(19) United States
(12) Patent Application Publication
(10) Pub. No.: US 2016/0281040 A1
(43) Pub. Date: Sep. 29, 2016

(54) Systems and Methods for Aging Beer Inside A Coconut

(71) Applicant: MAZURT, LLC, Atlanta, GA (US)

(72) Inventor: Daniel Rosen, Atlanta, GA (US)

(21) Appl. No.: 15/081,418

(22) Filed: Mar. 25, 2016

Related U.S. Application Data
(60) Provisional application No. 62/138,270, filed on Mar. 25, 2015.

(51) Int. Cl. C12H 1/22; C12C 11/11

(52) U.S. Cl. CPC C12H 1/22; C12C 11/11

(57) ABSTRACT

Described herein are systems and methods for aging beer inside a coconut. After selecting a suitable coconut of appropriate freshness and maturity, an opening may be placed in the shell through which coconut water may be removed and beer may be introduced. The opening may then be sealed and the coconut may be stored for a period of time. During storage, the coconut may impart a coconut flavor to the beer stored therein. Storage may be performed in a refrigerated environment to ensure the continued freshness of the beer and coconut, as well as the sanitation of the storage process. After sufficient storage to impart a desired amount or intensity of coconut flavor to the beer, the beer may be removed from the coconut. The coconut flavored beer may then be consumed, bottled, canned, kegged, or otherwise stored.

### PRIORITY INFORMATION

This application claims priority to U.S. Provisional Patent Application No. 62/138,270, which is incorporated herein in its entirety.

### BACKGROUND OF THE DISCLOSURE

With the proliferation of microbreweries in recent years, there is an ever expanding menu of beer infused with various flavors being brought to market. Among the flavors sometimes incorporated into a beer is coconut. This has been done in several ways, including adding toasted coconut meat, flaked coconut meat, or coconut milk either into the boil or added to the secondary fermenter during beer brewing and preparation. However, known methods involve heating, cooking, or fermenting the coconut ingredients. Thus, none of the known methods of infusing a coconut flavor into a beer yield a beer with a fresh coconut flavor. The potential health benefits associated with eating coconut may also be lost. Coconut products have been linked to the prevention of obesity, improving heart health, increasing fiber intake, improving digestion, and increasing energy. They also have a low glycemic index and contain no trans-fats.

Accordingly, systems and methods could benefit from improved devices and techniques for infusing beer with a fresh, balanced coconut flavor.

### SUMMARY OF THE DISCLOSURE

In accordance with certain embodiments of the present disclosure, systems and methods for aging beer inside a coconut are disclosed. In one aspect, suitable coconuts are provided. An opening may be placed in the coconut shell sufficient to remove any coconut water residing inside the shell. The interior cavity of the coconut shell may then be filled or partially filled with beer. After sealing the opening, the beer-filled coconut may be stored and/or refrigerated for a period time. During storage and/or refrigeration, the beer inside the coconut may be partially absorbed, expelled, and/or otherwise mixed with a coconut meat lining of the inner cavity of the coconut, imparting a natural coconut flavor to the beer.

In another aspect, the coconut selection, length of the storage or refrigeration (i.e., aging) process, and/or temperature at which the beer-filled coconut may be stored may all impact the amount or intensity of the coconut flavor imparted to the beer.

In a further aspect, each step in the disclosed process may be performed so as to ensure a desirable flavoring of the beer, as well as the continuous freshness and sanitation of the beer and coconut.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an illustrative embodiment of a method as described herein.

FIG. 2 depicts an illustrative embodiment of a system as described herein.

FIG. 3 depicts an illustrative embodiment of a system as described herein.

FIG. 4 depicts an illustrative embodiment of a system as described herein.

### DESCRIPTION OF EXEMPLARY EMBODIMENTS

Disclosed herein are various embodiments of systems and methods for aging beer inside of a coconut and infusing the beer with a natural coconut flavor. In some embodiments, a method may comprise: selecting a suitable coconut; placing an opening through the coconut's husk or shell; emptying any coconut water from the coconut through the opening; filling the interior cavity of the coconut with beer; sealing the opening of the coconut; allowing the beer to age inside of the coconut; and removing the coconut-aged beer from the coconut. Of course, this is only an illustrative embodiment and other methods may comprise fewer, additional, or alternative steps. Moreover, regardless of the order in which one or more steps may be presented in this disclosure, one of ordinary skill in the art may appreciate that some steps may be performed in a different order and/or concurrently with other steps.

Reference will now be made in detail to certain illustrative embodiments, examples of which are depicted in the accompanying drawings. Wherever possible, the same reference numbers will be used throughout the drawings to refer to the same or like items.

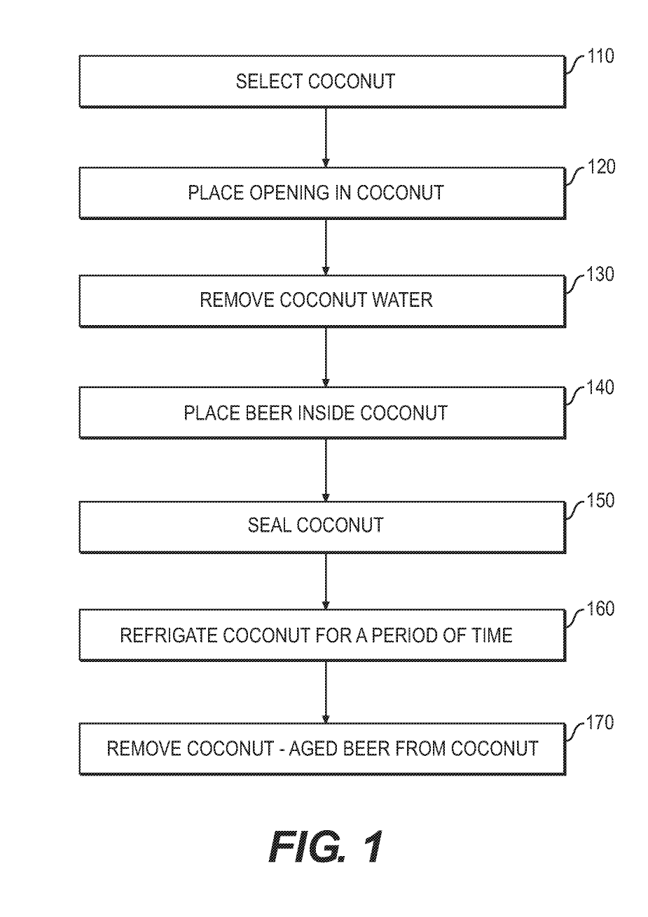

FIG. 1 illustrates one exemplary embodiment of a method for aging beer inside of a coconut. At step 110, a fresh and mature coconut is selected. Freshness may indicate that the contents of the coconut are sanitary, unspoiled, and uncontaminated. Maturity may ensure that the contents of the coconut are suitable for imparting the desired characteristics to a beer placed inside the coconut.

Generally speaking, coconuts initially emerge in bunches on a coconut tree and are green in color. Within six or seven months, the interior of a coconut may contain mostly water. This water may be harvested and is safe for human consumption. Over the next five to six months, the color of the coconut husk transitions from green, to white, to tan, to brown. During this period, the water inside the coconut is absorbed into the outer wall of the coconut, forming a white meat lining inside the shell. At first, the coconut meat is fairly soft. As the coconut reaches full maturity (after approximately one year), all of the water is absorbed and the meat hardens.

In one embodiment of the method disclosed herein, the freshness and maturity of a coconut may be determined by visual inspection. In particular, the color of the coconut husk may be assessed. A substantially tan or brown color may indicate freshness and maturity, while a substantially green or white color may be indicative of an immature coconut that has yet to ripen and/or contains little to no coconut meat.

The coconut may also be visually inspected for signs of external damage or deterioration. Coconuts comprising cracks, punctures, or leaks in the shell may have spoiled or may contain contaminants, and thus, may be discarded. In particular, the germination pores, or “eyes,” of the coconut should be inspected for damage or leakage, as the eyes of the coconut are typically the weakest area of the coconut shell.

Freshness may also be determined based on the feel of a coconut, which may be assessed through physical manipulation of the coconut. For example, the husk of a fresh and mature coconut may feel sufficiently moist and healthy. Coconuts having an overly dry or brittle husk may be discarded.

In another aspect, the presence or amount of coconut water within the coconut may be assessed or approximated. In one embodiment, the presence of coconut water within the coconut may be determined by physically shaking the coconut and feeling or listening for the displacement of coconut water. The absence of water may indicate a fully ripened coconut with a hardened interior layer of meat. On the other hand, if water can be heard or felt moving inside the coconut, this may indicate that the meat inside is still relatively soft and capable of absorbing additional water (or beer).

In one embodiment, coconuts may be selected that have a substantially brown or tan husk, in which the presence of coconut water can be detected. Such coconuts will have a relatively mature (or thick), yet soft meat layer suitable for imparting coconut flavor to a beer stored in the coconut's inner cavity.

A further aspect of coconut selection may be selecting an appropriate size of coconut. The size of a coconut may vary depending upon how much beer is to be placed inside the coconut. The larger the coconut, the more beer may be placed in the coconut, as described below with respect to step 140. Thus, to reduce the number of coconuts needed to age large amounts of beer, relatively large coconuts should be used for the aging process rather than smaller coconuts.

Once one or more suitable coconuts have been selected, at step 120 an opening is placed through the coconut's husk and shell, and into the interior cavity of the coconut. In one embodiment, the opening may be achieved using a drill. In other embodiments, any other suitable instrument or tool may be used to place an opening, hole, puncture, or orifice in the coconut shell. In one aspect, the opening may be large enough to allow any water inside the coconut to be poured out of the coconut and also large enough to allow for the injection or insertion of beer into the coconut.

In another aspect, the opening may be located at one of the coconut's germination pores or “eyes.” Typically, the eyes are the softest portions of the coconut shell and thus the most cost effective location for placing an opening. Of course, in other embodiments, an opening may be placed at any location in the coconut shell that facilitates the removal of water from the coconut and the introduction of beer. In still further embodiments, multiple openings may be placed in the coconut shell.

At step 130, and in one embodiment, substantially all of the coconut water residing inside the coconut is removed or poured out of the coconut. As described above, coconut water from a fresh coconut is sanitary and safe for human consumption. As a result, and in alternative embodiments, some amount of coconut water may be left in the coconut without risking contamination.

Beer may then be placed into the interior cavity of the coconut at step 140. In one embodiment, the beer placed inside the coconut may be any beer to which one desires to impart a coconut flavoring. In another aspect, the beer placed inside the coconut may be pre-chilled or refrigerated prior to placement in the coconut to a temperature low enough to ensure the continued sanitation, freshness, and flavor characteristics of the beer. In one embodiment, the beer may be chilled to a temperature between approximately 28° F. (−2° C.) and approximately 45° F. (7° C.). Placing chilled beer inside the coconut may not only ensure that the beer remains fresh, but it may also ensure the continued freshness of the coconut and avoid the possibility of heating, toasting, or cooking the contents of the coconut. Placing cold beer inside the coconut may also help reduce energy consumption when the filled and sealed coconut is stored and/or refrigerated during aging, as described below with respect to step 160.

In one embodiment, the coconut may be oriented such that the opening(s) is placed at or near the highest point (or top) of the coconut. In such an embodiment, a hose or other conduit may be fed through the opening and a distal end of the hose or conduit may be located at or near the lowest point (or bottom) of the coconut. In this manner, as beer is placed into the inner cavity of the coconut through the conduit (for example, pumped via a CO₂ source), the beer fills the coconut cavity from the bottom up and any splashing or pouring that may result in excess carbonation (i.e., foam or head) filling the coconut may be reduced.

In another aspect, after the coconut has been substantially filled with beer, the hose or conduit may be removed. In one embodiment, as the conduit is withdrawn or after the conduit has been withdrawn from the coconut, additional beer may be placed into the coconut to account for any displaced volume vacated by the conduit.

In other embodiments, some other device or method may be used to place beer inside the coconut, for example, a funnel or syringe may be used to direct beer into the coconut.

At step 150, the coconut may then be sealed to prevent beer from spilling or leaking from the coconut. A seal may also prevent outside contaminants from entering the coconut. In one embodiment, the coconut may be sealed immediately upon removal of the hose and/or immediately upon filling the interior cavity of the coconut with beer in order to reduce the risk of contaminants entering the coconut.

In one embodiment a cork or other seal body having a cross-section substantially similar to the cross-section of the opening in the coconut may be used to seal the opening. For example, in embodiments in which the opening may be created using a ⅜″ drill bit, a cork or body having a substantially circular cross-section and a diameter of approximately ⅜″ or slightly greater may be used to seal the coconut. In further embodiments, a cork or other body may exhibit a tapered cross-section such that a first end of the cork or body may easily fit within the opening but a second end of the cork or body may be substantially larger than the opening. In this manner, the cork or body may be placed snuggly in the opening and a tight, spill-proof, and contaminant-resistant seal may be formed.

In alternative embodiments, the coconut may be sealed with other devices and/or using other methods. For example, the opening in the coconut may be sealed using a plastic or epoxy seal that may be applied in a substantially liquid or gel-like form that quickly solidifies at room temperature or in the presence of refrigeration. In still further embodiments, a port or tap may be inserted into the opening that mates with a threaded or compression-fitting cap. In still further embodiments, the opening may be sealed in any manner suitable to prevent spilling, leakage, and/or the introduction of contaminants into the coconut.

The sealed coconut may then be refrigerated for a period of time at step 160. In one aspect, the sealed coconut should be refrigerated immediately or shortly after completion of sealing to safeguard against spoilage and ensure continued sanitation. In other embodiments, the coconut may be refrigerated prior to or during any of the aforementioned steps to either assure continued sanitation of the coconut, the freshness of the beer placed in the coconut, and/or to reduce energy costs associated with aging the coconut in a refrigerated environment.

In one embodiment, the beer-filled coconut may be refrigerated for a period of approximately four days. In other embodiments, the beer-filled coconut may be refrigerated for a shorter time period or a longer time period. In still further embodiments, the beer-filled coconut may be refrigerated for any period of time necessary to impart the desired level or intensity of coconut flavor to the beer inside the coconut cavity.

During the aging process (the period during which the beer-filled coconut is refrigerated) the beer may be partially absorbed, expelled, and/or otherwise mixed with the meat layer of the coconut interior cavity. This absorption, expulsion, and mixing imparts a coconut flavoring to the beer inside the coconut. If the beer is aged (i.e., the sealed coconut is refrigerated) for too short a period of time, the beer will not exhibit sufficient coconut flavor. Conversely, if the beer is aged (i.e., the sealed coconut is refrigerated) for too long a period of time, the beer will exhibit too much coconut flavor and may not be appealing in taste to consumers.

In one embodiment, the beer-filled coconut may be refrigerated at a temperature between approximately 28° F. (−2° C.) and approximately 45° F. (7° C.). In other embodiments, the beer-filled coconut may be refrigerated at some other temperature that may ensure the continued freshness of the coconut and beer, avoid spoilage of the coconut and beer, and promote sanitation.

In still further embodiments, the amount of time that a beer-filled coconut may be refrigerated (i.e., the amount of time beer may be aged inside the coconut) may be partially dependent on the refrigeration temperature. For example, the beer inside coconuts stored at 28° F. may age (i.e., take on a coconut flavor) slower than beer inside coconuts stored at a higher temperature, e.g., 40° F.

In another embodiment, the amount of time that a beer-filled coconut may be refrigerated (i.e., the amount of time beer may be aged inside the coconut) may be partially dependent on the size of the coconut and/or the size of the interior cavity of the coconut. In particular, the ratio of, on the one hand, the surface area of the interior cavity of the coconut in contact with the beer to, on the other hand, the volume of beer inside the coconut may impact the length of time that the beer may be aged inside the refrigerated coconut. For example, relatively small coconuts may have a larger interior surface area to beer volume ratio than exhibited by relatively large coconuts. As a result, beer may age faster in smaller coconuts so smaller coconuts may be refrigerated for less time when compared to larger coconuts.

At step 170, after the beer has aged inside the refrigerated coconut for a period of time sufficient to impart a desirable amount or intensity of coconut flavor to the beer, the seal may be removed from the opening and the coconut-aged beer may be removed from the coconut. In another embodiment, rather than removing the seal from the opening, a new opening may be placed in the same or a different location of the coconut shell in order to retrieve the coconut-aged beer.

The coconut-aged beer may be removed from the coconut by pouring the beer from the opening(s) or by pumping the beer through the opening(s). In another embodiment, the coconut-aged beer may pass through a filter or screen as or after leaving the coconut in order to remove any coconut solids that may be present in the beer. For example, coconut shavings resulting from creation of the opening(s), including pieces of husk, shell, and meat, may be filtered from the beer.

The coconut-aged beer may be poured directly from the coconut into a glass for consumer consumption, or the beer may be otherwise stored for later consumption, i.e., bottled, canned, kegged, or otherwise stored.

In one aspect, after the beer has been removed from the coconut, the empty coconut may be reused to age additional beer. In one embodiment, because the coconut meat may still contain some amount of beer (i.e., some amount of beer has already been absorbed into the meat), aging of beer in a previously-used coconut may be accelerated (i.e., it may take a shorter storage/refrigeration period to achieve the same level of coconut flavor in the beer). For example, whereas the aging process (i.e., the amount of time a beer-filled coconut may be stored/refrigerated) may be approximately four days for a coconut that has never been used to age beer, the aging process may be shortened to three days or some other period of time shorter than four days for re-used coconuts that have been previously used to store beer, while still imparting substantially the same amount of coconut flavor to the beer stored therein.

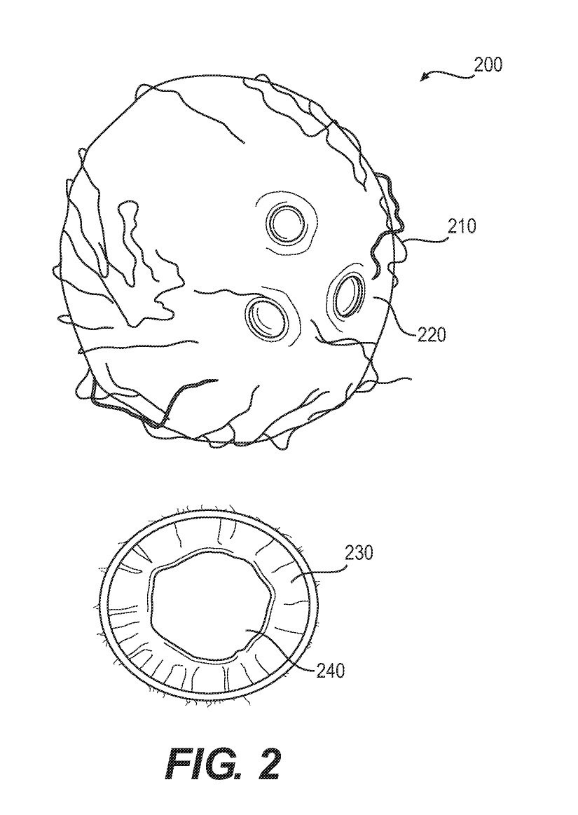

FIG. 2 depicts a coconut 200 suitable for use in the disclosed systems and methods. In one aspect, coconut 200 may comprise a shell and husk 210. Shell 210 may comprise one or more germination pores or “eyes” 220. The inner wall of shell 210 may comprise a meat layer 230. In another aspect, meat layer 230 may define an inner cavity 240. During coconut maturation, inner cavity 240 may comprise coconut water that may be absorbed by meat layer 230 over time and as the coconut ripens.

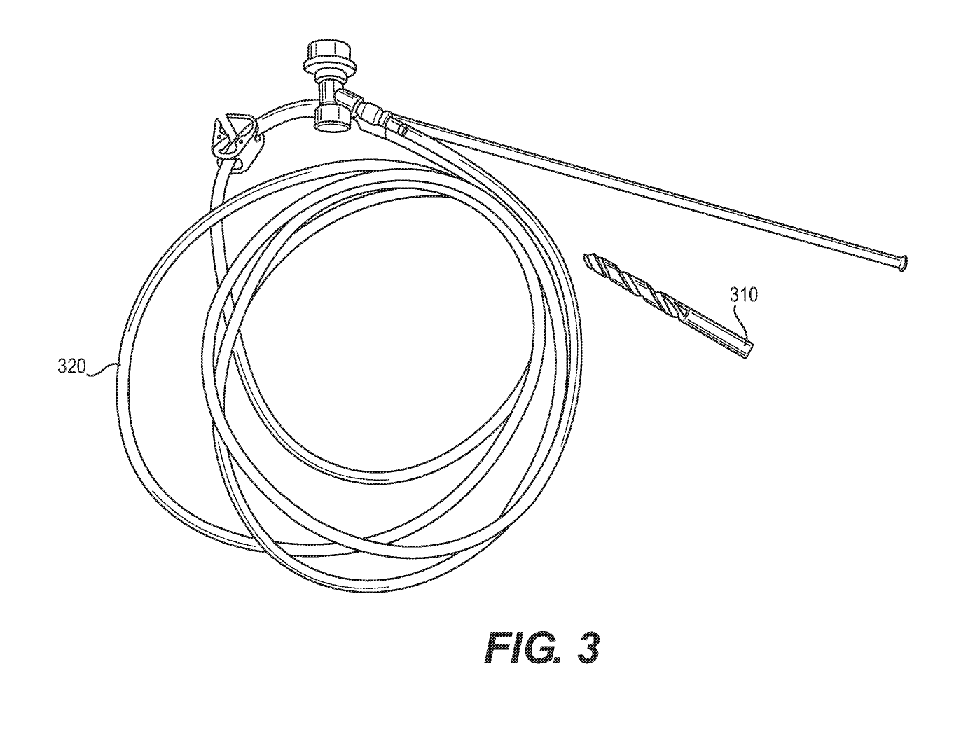

FIG. 3 depicts a drill bit 310 suitable for placing an opening in coconut 200. In one embodiment, drill bit 310 may be used to locate an opening at one or more of eyes 220 of coconut 200 or at some other location on shell 210.

FIG. 3 further depicts hose or conduit 320. Conduit 320 may be used to place beer inside coconut 200 through an opening. In one embodiment, a distal end of conduit 320 may be placed inside coconut 200 and conduit 320 may be in fluid communication with a beer source and/or a CO₂ source for pumping beer into the coconut.

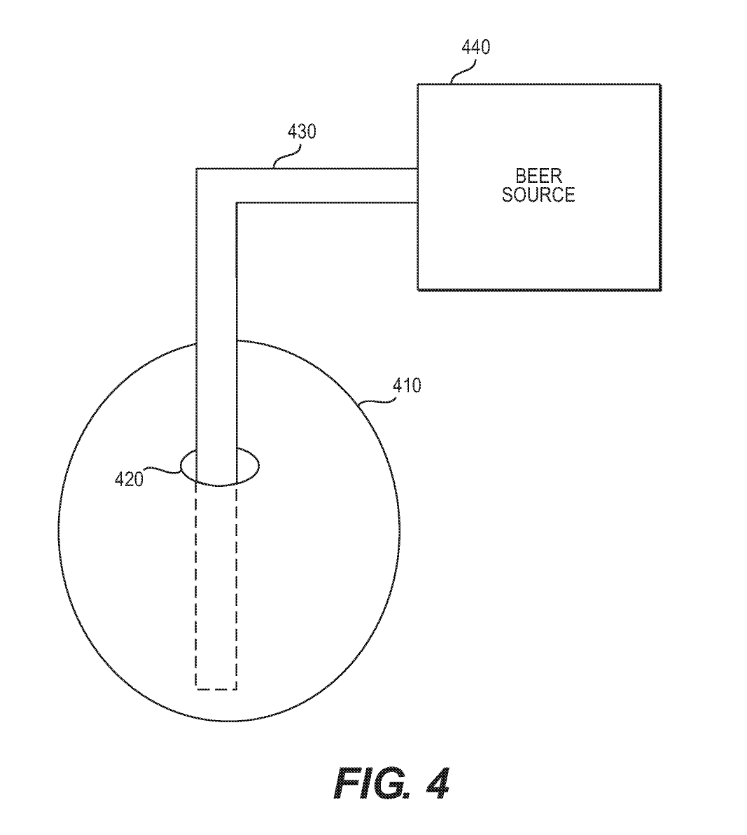

FIG. 4 depicts an interior cavity of a coconut 410 in fluid communication with a beer source 440 via a conduit 430. In one aspect, conduit 430 may pass through an opening 420 in coconut 410. In another aspect, a distal end of conduit 430 may be located at or near a bottom of the inner cavity of coconut 410 and a proximal end of conduit 430 may be in communication with beer source 440. In other embodiments, a CO₂ source may be used to propel, pump, or displace beer from beer source 440 to coconut 410.

Other embodiments of the aforementioned systems and methods will be apparent to those skilled in the art from consideration of the specification and practice of this disclosure. It is intended that the specification and the aforementioned examples and embodiments be considered as illustrative only, with the true scope and spirit of the disclosure being indicated by the following claims.

What is claimed is:

1. A system for aging beer inside a coconut, the system comprising:
a coconut comprising a shell defining an interior cavity;
a beer source; and
a conduit having a distal end and a proximal end, the distal end located within the coconut and the proximal end in fluid communication with the beer source.

2. The system of claim 1, further comprising a device for placing an opening in the coconut shell, the opening configured to receive the conduit.

3. The system of claim 2, wherein the device for placing an opening in the coconut shell is a drill.

4. The system of claim 1, further comprising a CO₂ source for displacing beer from the beer source to the interior cavity of the coconut.

5. The system of claim 2, further comprising a body having a cross-section substantially similar to a cross-section of the opening, such that the body is configured to seal the coconut when the body is located within the opening.

6. The system of claim 1, further comprising a refrigeration unit for storing the coconut for a period of time.

7. The system of claim 1, wherein the beer source contains refrigerated beer.

8. The system of claim 1, wherein the beer source contains beer at a temperature between about 28° F. and about 45° F.

9. The system of claim 1, wherein the coconut is pre-chilled.

10. The system of claim 1, wherein the coconut is positioned such that the beer source can displace beer to the interior cavity of the coconut via a gravity feed.

11. A method for aging beer inside a coconut, the method comprising:
selecting a coconut comprising a shell, the shell defining an interior cavity;
placing an opening in the coconut through the shell;
removing coconut water from the interior cavity through the opening;
placing beer inside the interior cavity through the opening;
sealing the opening;
storing the coconut for a period of time; and
removing the beer from the interior cavity through the opening.

12. The method of claim 11, wherein selecting the coconut comprises selecting a coconut comprising a meat layer at the inner surface of the shell.

13. The method of claim 11, wherein selecting the coconut comprises selecting a coconut comprising a meat layer at the inner surface of the shell and coconut water in the interior cavity.

14. The method of claim 11, wherein placing beer inside the interior cavity through the opening comprises:
placing a conduit through the opening, the conduit being in fluid communication with a beer source; and
displacing beer through the conduit from the beer source to the interior cavity.

15. The method of claim 11, wherein placing beer inside the interior cavity comprises pumping the beer via a CO₂ source.

16. The method of claim 11, wherein placing beer inside the interior cavity comprises utilizing a gravity feed.

17. The method of claim 11, wherein storing the coconut for a period of time comprises storing the coconut for four days.

18. The method of claim 17, further comprising, after removing the beer from the interior cavity through the opening:
placing fresh beer inside the interior cavity of the coconut; and
storing the coconut for a second period of time, the second period of time being shorter than the first period of time.

19. The method of claim 11, wherein storing the coconut comprises storing the coconut at a temperature of between about 28° F. and about 45° F.

20. The method of claim 11, further comprising chilling the beer before placing beer inside the interior cavity through the opening.
